(19) United States
(12) Patent Application Publication
(10) Pub. No.: US 2007/0140050 A1
(43) Pub. Date: Jun. 21, 2007

(54) Concrete slurry tank

(75) Inventor: Scott Humphrey, Tracy, CA (US)

Correspondence Address: MARK D MILLER;KIMBLE, MACMICHAEL & UPTON, 5260 NORTH PALM AVENUE, SUITE 221, FRESNO, CA, 93704, US

(73) Assignee: Dave Humphrey Enterprises, Inc.

(21) Appl. No.: 11/640,047

(22) Filed: Dec. 15, 2006

Related U.S. Application Data
(60) Provisional application No. 60/752,252, filed on Dec. 19, 2005.

(51) Int. Cl. B01F 7/16

(52) U.S. Cl. 366/262

(57) ABSTRACT

The present invention generally provides a modular apparatus for storing and maintaining variable amounts of concrete slurry, and methods for assembling, utilizing and cleaning the apparatus. The modular nature of the apparatus permits a slurry manufacturer to create and store different volumes of slurry without resorting to multiple storage containers. It further permits a slurry manufacturer to clean the storage container on a regular basis without the expensive and time-consuming process of vertically inserting personnel and equipment through the open top of the container. Embodiments of the invention include a water jacket for use in maintaining the temperature of the slurry in the container.

This application claims the benefit of U.S. Provisional Application No. 60/752,252, filed on Dec. 19, 2005, which is incorporated herein by this reference.

### BACKGROUND OF THE INVENTION

1. Field of the Invention

The present invention relates to apparatus and methods for storing concrete slurry and maintaining it in an agitated state, and more particularly, to modular apparatus and methods of maintaining agitated slurry at a pre-defined and constant temperature.

2. Description of the Prior Art

The concrete slurry used in the construction industry generally comprises a mixture of water, cementation materials and sand fines. The slurry is generally ordered in advance, pre-mixed at an off-site concrete batch plant to particular specifications, and then delivered to the job site in trucks with large rotatable drums that continuously agitate the slurry until it is ready to be used. The unused slurry is returned to the plant, where it may be recycled, reclaimed or stored until it is needed again.

Throughout this entire process, and until it is poured, the slurry must be maintained in an agitated condition. Failure to do so will cause the slurry to harden prematurely, and become useless. As such, most slurry manufacturers use specially designed slurry containers to continuously agitate the unused or returned slurry.

Traditional slurry containers include a cylindrical upright drum with an agitator extending downward into the slurry mixture. A significant shortcoming of such a container is that it cannot be expanded to accommodate different volume requirements. As such, if the volume of slurry exceeds the capacity of a single container, the excess volume must be stored in additional, separate containers.

Separate storage creates numerous problems in maintaining a consistent quality in a single batch of slurry. Because the slurry must be mixed and maintained in separate containers, minute differences in the ingredients, water-mix ratios, temperatures, consistencies, or even locations, may result in different slurry qualities—which may dilute or contaminate the entire batch, and cause unanticipated effects on architectural stress points or defects in the concrete, or things as simple as color mis-matches.

Purchasing a separate, larger container is an expensive and wasteful alternative, since the larger container cannot effectively mix smaller volumes of slurry.

A second significant shortcoming of the traditional slurry container is that it, is difficult to clean. Regular cleaning is essential in avoiding contamination of the slurry.

However, the only means of cleaning a traditional slurry container is through the open top end of the container—which often necessitates manual cleaning.

A third significant shortcoming of the traditional slurry container is that it does not effectively regulate the slurry temperature. Heat affects the quality of the concrete, in that the slurry will solidify faster as more heat is applied. However, too much heat will result in weak or substandard concrete. The mere creation of the slurry, and its subsequent constant agitation, generates heat. Additional sources of heat include the warmer summer months and geographic climates.

Various inventions have been developed to address one or more of these problems. For example, U.S. Pat. No. 3,930,462 discloses a slurry tank having a crude water jacket along two sides and the bottom of a tank for regulating slurry temperature. However, there is no temperature control for the remaining sides of the tank, making it difficult to attain consistent temperature regulation. U.S. Patent Application No. 2003/0002384 discloses a portable concrete batch plant for onsite mixing of slurry having a slurry mixing component with a heat exchanger and hot water system. However, the exchanger and system control the temperature of the water used in creating the slurry in the first place; there is no separate system for use in maintaining the temperature of the slurry once created.

In addition, neither of the above inventions is able to store variable volumes of slurry. The capacity of the '462 invention is limited to the physical dimensions of the container, with excess volumes requiring additional containers. Though the '384 invention is arguably capable of mixing a large volume of slurry, that slurry must be used immediately—the invention's ability to store slurry is limited to the capacity of the storage component, which must be small enough for the invention to remain portable. Finally, neither of the above inventions are any easier to clean than a traditional slurry container, since both of them still must be cleaned through their respective open tops.

It is therefore desirable to provide apparatus with expandable capacity to accommodate different volumes of slurry, and methods of use. It is further desirable to provide apparatus and methods including components to effectively regulate the slurry temperature. It is further desirable that the temperature be efficiently regulated regardless of the slurry volume, without exposing any portion of the slurry to temperature extremes or otherwise affecting the quality of the concrete. Finally, it is desirable to provide methods and apparatus for easily cleaning a slurry tank on a regular basis.

### SUMMARY OF THE INVENTION

The present invention provides a modular apparatus for storing variable amounts of concrete slurry, and methods of use. One embodiment includes one or more base panels attached together to form a base panel assembly or foundation, and a plurality of upwardly extending side panels attached to the perimeter of the foundation. The foundation and side panels form a slurry container having a closed bottom and sides. The dimensions and shape of the container may be altered according to the slurry manufacturer's needs, simply by adding or removing the appropriate number of base and side panels.

The modular nature of the present invention provides an easy means of cleaning the slurry container. Rather than vertically inserting cleaning personnel and equipment, the slurry manufacturer may simply remove one or more side panels or end walls in order to access the interior for cleaning and maintenance purposes. This permits the manufacturer to utilize a wider range of cleaning equipment, including the use of a skid steer (Bobcat®) or other front loading excavator for removal of residual concrete during periodic cleaning. The removable panels also allow the modular invention to be expanded by adding additional base and wall panels at any such opening, resulting in a larger enclosure made up of multiple modules attached to each other.

The present invention further allows a slurry manufacturer to regulate the temperature of the slurry in the tank via the introduction of temperature regulating fluids through a modular water jacket. The modular water jacket is constructed from a second set of side panels erected around the existing side panels, with a space between the exterior and interior panel sets defining the water jacket itself. The flow of heated or cooled fluids through the water jacket regulates the temperature of the slurry in the tank.

Some embodiments of the water jacket of the present invention include a series of channels to control the flow of the temperature regulating fluids. These channels may be formed by the support structures attached to each side panel, and/or by various flow openings within said support structures. These channels provide a more uniform distribution of fluid through the water jacket providing more thorough heating or cooling of the slurry, preventing the disproportionate heating or cooling of different areas within the water jacket and adjacent slurry.

It is therefore an object of the present invention to provide a modular slurry tank that may be expanded or contracted in order to change its slurry holding capacity according to the needs of the user.

It is therefore an object of the present invention to provide a modular slurry tank that allows for future growth of the slurry tank by adding additional side and bottom panels.

It is another object of the present invention to provide methods and apparatus for effectively regulating the temperature of the slurry in the tank without diluting, or otherwise negatively affecting, the quality of the slurry.

It is another object of the present invention to provide a temperature regulating mechanism capable of accommodating different dimensions of the tank, and changes in those dimensions.

It is another object of the present invention to provide a slurry tank that is easy and inexpensive to clean on a regular basis.

Additional objects of the invention will be apparent from the detailed description and the claims herein.

### BRIEF DESCRIPTION OF THE DRAWINGS

FIG. 1 is a side perspective view of an embodiment of the invention.

FIG. 2 is a top plan view of the embodiment of FIG. 1.

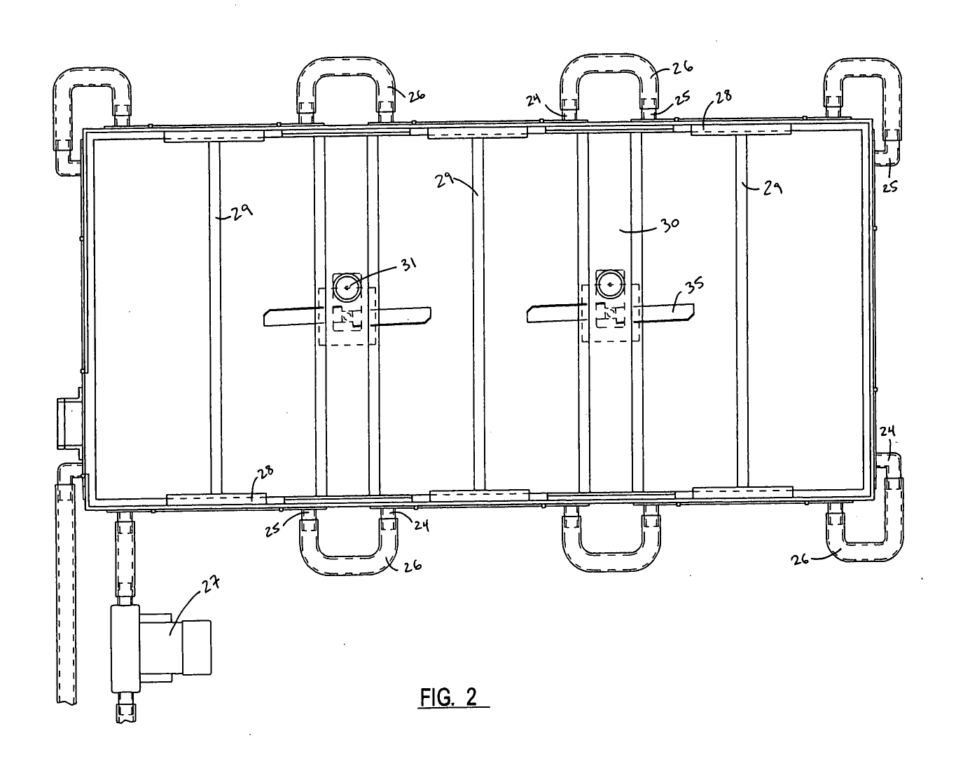

FIG. 3 is a cross sectional side view along line 3-3 of FIG. 1.

FIG. 4 is a cross sectional top view along line 4-4 of FIG. 1.

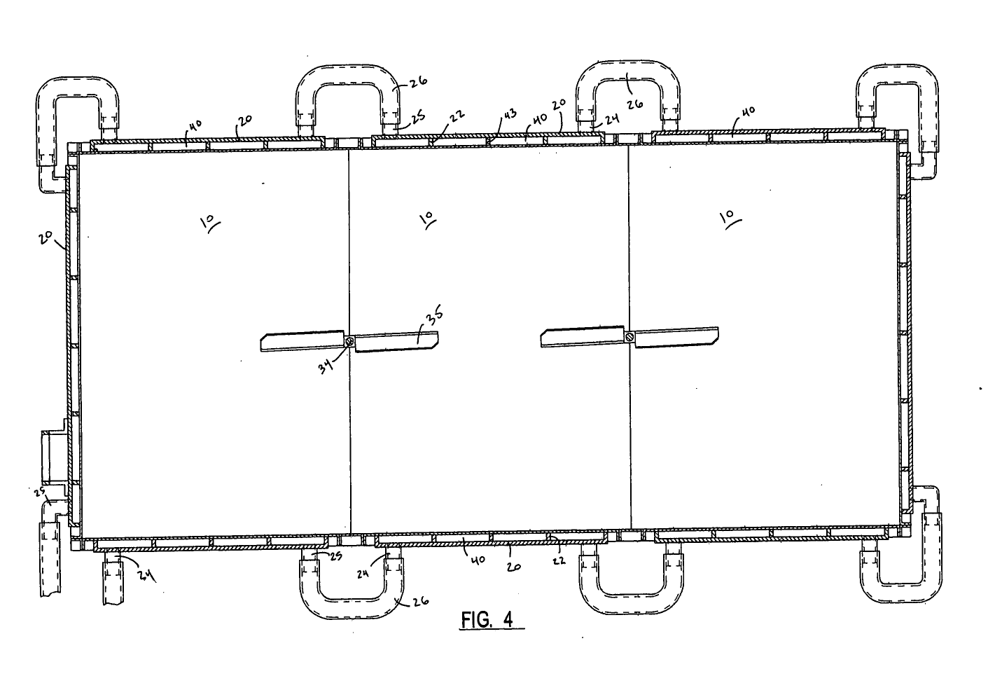

FIG. 5 is a cross sectional end view along line 5-5 of FIG. 1.

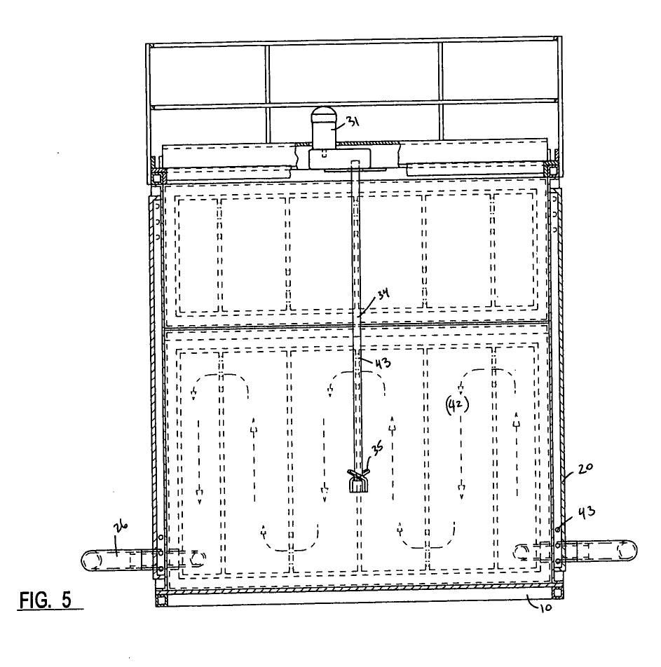

FIG. 6 is a perspective view of an embodiment of the invention showing a side wall having been removed.

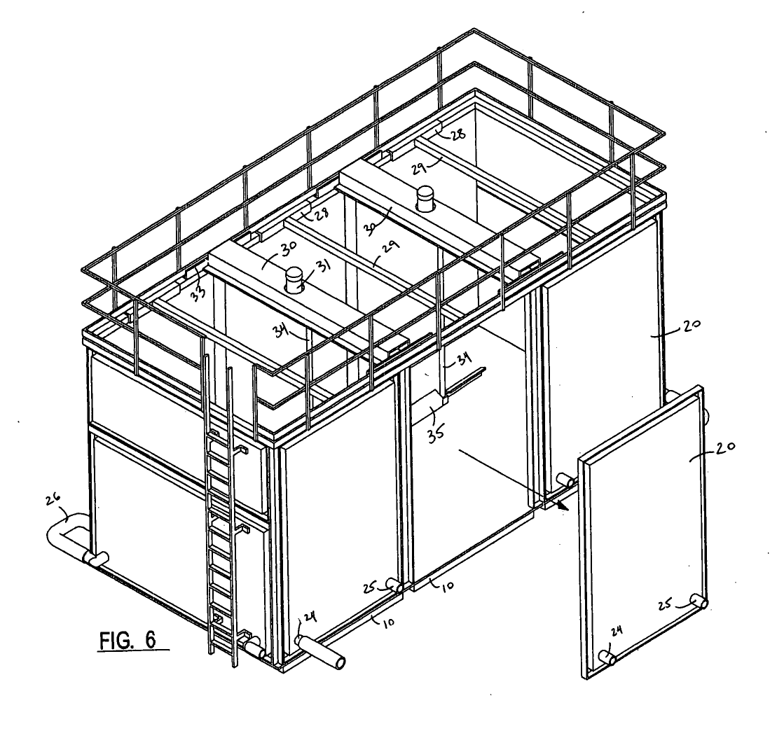

FIG. 7 is a side perspective and partially cut away view of an embodiment of a panel of a water jacket of the present invention.

FIG. 8 is a side view of an embodiment of the present invention, illustrating expandability (modularity) in phantom lines.

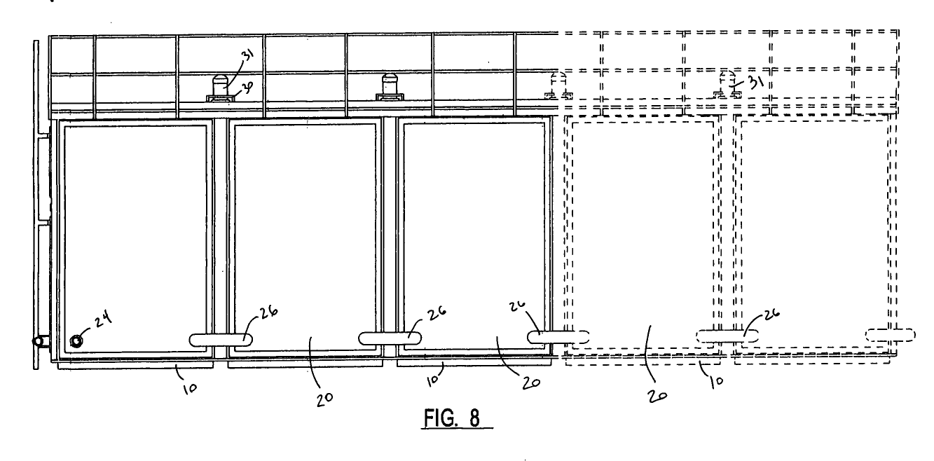

### DETAILED DESCRIPTION

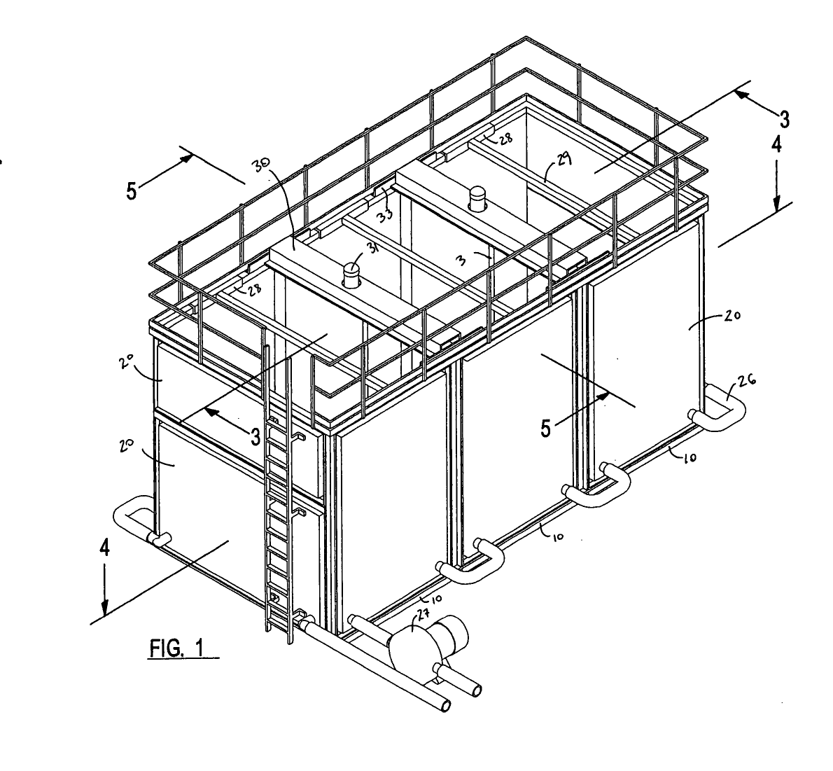

Referring to the drawings wherein like reference characters designate like or corresponding parts throughout the several views, and referring particularly to the exemplary embodiment of FIG. 1, it is seen that the present invention includes a slurry container generally having one or more base panels 10 forming a foundation, and a plurality of upwardly extending side panels 20.

Each base panel 10 may be provided with one or more attachment devices 11 along the edges of the base panel 10 for interengagement with other base panels 10 or side panels 20. Although the illustrated embodiment is depicted in a generally rectangular form, it is to be appreciated that base panel(s) 10 may be of any shape or dimension including without limitation, pentagonal, hexagonal, octagonal, round, oval, etc. The attachment mechanisms 11 may be any number of devices for securing one object to another, including, but not limited to bolts, hooks, latches, male-female joints, teeth, etc., or combinations thereof. The attachment mechanisms 11 of each base panel 10 may be interlocked with the corresponding attachment mechanism 11 of another base panel 10, or with a similar attachment mechanism 21 of a side panel 20.

Each side panel 20 also includes one or more attachment mechanisms 21 along one or more edges of the side panel 20 for engagement with base panels 10 and/or other side panels 20. The attachment devices 21 may be interlocked with the corresponding attachment mechanism 21 of another side panel 20, or with the attachment mechanism 11 of a base panel 10. Although the illustrated embodiment is depicted in a generally rectangular form, it is to be appreciated that side/end panel(s) 20 may be of any shape or dimension including without limitation, rectangular, square, etc., and may have any suitable cross sectional shape including L-shaped, T-shaped, arcuate, or combinations thereof.

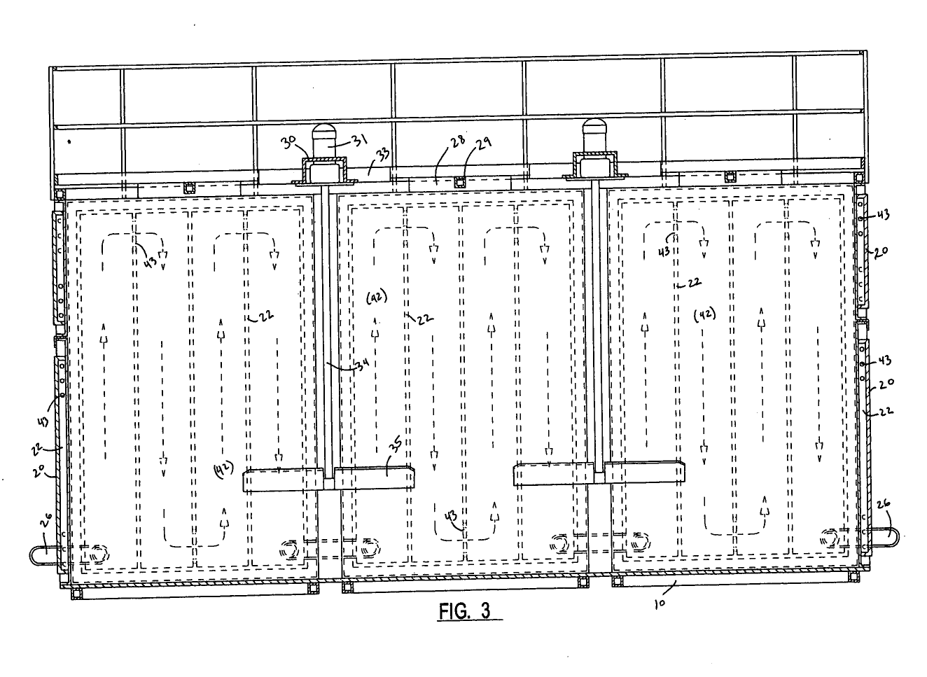

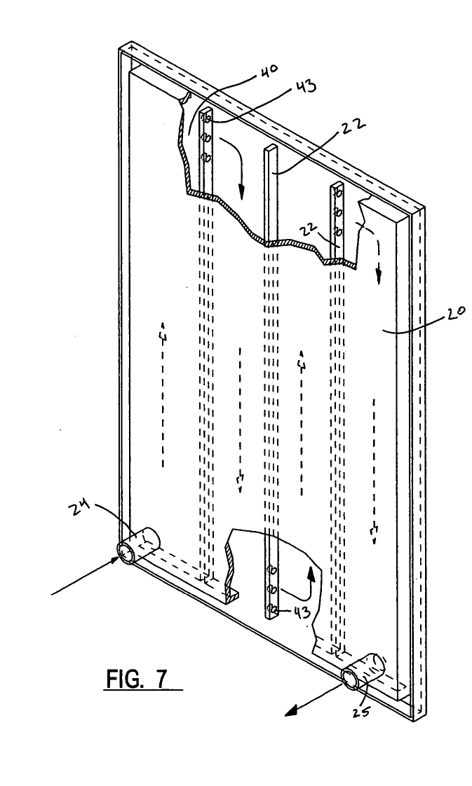

In several embodiments, side panels 20 also include reinforced support structures 22 as shown in FIG. 3. The support structures 22 may be affixed to one or both faces of each side panel 20, or even embedded within the side panels 20 as shown in FIG. 7.

The above described attachment mechanisms 11, 21 allow a slurry manufacturer to interlock any two or more panels via their edges (either two base panels, a base panel and a side panel, two side panels, side/end panel(s), or any combination of a plurality of panels). When interlocked, the panels form a tight seal along the edge of the junction sufficient to prevent the outflow of liquids. The combination of any number of base panels 10 permits the expansion of the present invention's horizontal dimensions (foundation) to accommodate different volumes of slurry, and to form irregular shapes to accommodate space restrictions imposed by the environment. The connectivity between the base panels 10 and side panels 20 allows the side panels 20 to fully enclose the perimeter defined by the base panels 10 assembly (foundation), regardless of the particular dimensions of the base 20 panels themselves.

In some embodiments, one or more support members 33 are provided, generally in pairs, for attachment to the tops of side panels 20. Support beams 30 are attached to the support members 33, ordinarily located on opposite pairs of side panels 20. Support members 33 provide reinforcement between adjacent side panels 20, and provide a cross support for the enclosure through beam 30 to ensure that the side panels 20 do not collapse or deform under the pressure of the contained slurry. Agitator assemblies 31 may be mounted upon one or more of the support beams 30, each assembly 31 including a shaft 34 and blades 35 used to agitate the slurry contained within the present invention. In some embodiments, additional support members 28 are provided at the tops of side panels 20, with cross beams 29 provided between them to further reinforce panels 20.

In some embodiments of the present invention, a modular water jacket is provided for maintaining the temperature of the concrete slurry in the container. In these embodiments, side panels 20 are provided with dual walls defining a space 40 therebetween as more fully illustrated in FIGS. 3 and 7. The space 40 may be filled with a temperature regulating fluid, such as water, which is injected through an inlet 24 provided on the exterior of a side panel 20, and removed through a separate outlet 25. The fluid is circulated either via the injection pressure or separate pumping mechanism(s) 27. It is to be appreciated that multiple side panels 20 having dual walls with inlets 24 and outlets 25 may be provided, and that the outlet 25 from one side panel may be connected to the inlet 24 of an adjacent side panel via a piping structure 26, such that the fluid may be circulated from one side panel 20 to another. It is also to be appreciated that not all side panels 20 need be included in the circulation of fluid, although this is preferred so as to maintain uniform temperature regulation. Temperature regulating units such as heaters or coolants, may be utilized to maintain a desired fluid temperature, which, in turn, affects the temperature of the slurry in the container. Additional insulating panels or liners may also be employed, particularly on the exterior wall, to maintain the temperature inside. An exemplary hot temperature for the fluid is around 165 degrees F., and an exemplary cold temperature is around 37 degrees F., it being understood that any suitable temperature above, or below this range may be used depending upon the air temperature, the starting temperature of the slurry, and the desired temperature for the slurry.

With respect to the flow of fluid through the space 40 of each side panel 20, it is to be appreciated that structures 22 define one or more channels 42 between them, either in uniform or non-uniform positions with respect to one another. See FIGS. 3 and 7. In some embodiments, support structures 22 may be sized such that they do not fully extend from one end of panel 20 to the other, thereby defining one or more gaps through which fluid may flow. In other embodiments, one or more openings 43 may be provided in structures 22 to allow the flow of fluid to pass through, as shown in FIG. 3. Openings 43 may be located in the same positions on each structure 22, but are preferably in different locations (e.g., at the top of one structure 22, and at the bottom of an adjacent structure 22) in order to force the fluid to flow in a longer path for more uniform distribution in the space 40. Flow openings 43 may have the same or different diameters. The channel(s) 42 and flow openings 43, separately or together, preferably guide the flow of pressurized fluids to all parts of the water jacket spaces 40 to provide more thorough heating or cooling of the slurry, and prevent disproportionate heating or cooling of different areas within the water jacket and adjacent slurry. In the illustrate embodiment, structures 22 and openings 43 provide a serpentine channel 42 for the flow of fluids.

It is to be appreciated that multiple, concentrically-located water jackets may be used if necessary. This permits the slurry manufacturer to heat or cool the inner portions of the slurry container, rather than merely the outside edges.

In use, the slurry manufacturer determines desired dimensions for the slurry container based upon anticipated needs. The base of the slurry container is assembled by combining the necessary base panels 10, and attaching them to one another via the interlocking attachment mechanisms 11. The side panels 20 are attached around the perimeter of the base panels 10 assembly via the interlocking attachment mechanisms 11, 21. Support members 33 and beams 30 are then attached to the top edges of opposing side panels 20, and agitator assemblies 31 mounted thereon. Additional supports 28, 29 may also be installed. The slurry is then introduced into the slurry container and periodically (or continuously) agitated by the agitator assemblies 31 until it is ready to be disbursed.

Should it be determined that the slurry container should be larger, one or more side (end) panels 20 may be removed creating an opening, and additional base panel(s) 10 attached to the existing base assembly at the opening. Then, additional side panels 20 may be attached around the perimeter of the new base panel(s) 10, attaching to themselves and to the existing side panels 20. This expands the capacity of the container to handle more slurry. It is to be appreciated that such expansion may be accomplished by the removal of any one or more side panels, and the addition of any one or more base panels and additional side panels to enclose the container. An exemplary expansion adding two base panels and associated side panels is illustrated in the phantom lines in FIG. 10. It is to be appreciated that the container may be reduced in size by performing the reverse of the operation above: removal of a section of side panels (and corresponding base panel(s)) and closing off the open end to form a smaller container tank. It is also to be appreciated that multiple containers of the present invention may be attached to each other using one or more common side walls, and/or that a container of the present invention may be divided into sections by inserting one or more side walls between existing side walls.

If the temperature of the slurry is to be maintained at a certain level, side panels 20 may be of the water jacket type illustrated in FIG. 7, having dual walls defining a space 40 between them, with channel(s) 42 defined between supports 22, and openings 43 in supports 22 for the flow of fluid through space 40. A fluid pipe is attached to inlet 24 to introduce a temperature regulating fluid into the space 40 by means of one or more pumps 27. This fluid exits through outlet 25, which is connected to the inlet 24 of an adjacent panel, and so on, so that fluid is circulated throughout spaces 40 of each connected panel 20 of the water jacket. The fluid is pre-heated or pre-cooled as dictated by such things as the slurry type and temperature, weather conditions, etc. The fluid transfers the heat or coolness to the slurry in the container, and helps maintain the slurry at a suitable temperature for good quality under wide ranging conditions.

Cleaning of the slurry container is a simple operation. One or more side panels 20 are removed from the container. This allows personnel and equipment to enter the container from the side for periodic cleaning maintenance. Since the avenue of entrance is through a side panel 20, the slurry manufacturer is not limited to the vertical insertion of specialized cleaning equipment. Instead, the manufacturer may utilize any number of generic, non-specialized machines, such as a traditional skid steer or Bobcat®.

It is to be understood that variations and modifications of the present invention may be made without departing from the scope thereof. It is also to be understood that the present invention is not to be limited by the specific embodiments disclosed herein, but only in accordance with the final claims when read in light of the foregoing specification.

What is claimed is:

1. A container for holding concrete slurry comprising:
a. a base; and
b. a plurality of removable, upwardly extending side panels attached around the perimeter of the base and to each other defining an enclosure having a base with enclosing sides and an open top.

2. The container of claim 1, wherein said base further comprises a plurality of separate panels affixed to one another, and wherein a sufficient number of side panels are provided to extend around the perimeter of said base.

3. The container of claim 1, further comprising a plurality of interior compartments for separately storing portions of concrete slurry.

4. A container for holding concrete slurry comprising:
a. a base; and
b. a plurality of removable, upwardly extending side panels attached around the perimeter of the base and to each other defining an enclosure;
wherein at least one of said side panels further comprises an inner and outer wall defining a closed space therebetween, an inlet and an outlet in fluid communication with said space, and at least one channel for the flow of fluid defined in said space between said inlet and said outlet.

5. The container of claim 4 wherein said at least one side panel further comprises at least one support member provided in said space, said member further defining the path of said at least one channel.

6. The container of claim 5 wherein said at least one support member further comprises at least one opening therein further defining the path of said at least one channel.

7. The container of claim 6 wherein a plurality of support members are provided in said space, and the at least one opening on adjacent members is alternatingly provided at opposite ends thereof.

8. The container of claim 4 wherein said channel has a serpentine path.

9. The container of claim 4 wherein the inlet of said at least one side panel is in fluid communication with a pump, and the outlet of said at least one side panel is in fluid communication with an inlet of another side panel.

10. A container for holding concrete slurry comprising:
a. a base;
b. a plurality of removable, upwardly extending side panels attached around the perimeter of the base and to each other defining an enclosure with an open top; and
c. at least one agitator disposed in said container,
wherein each of said side panels further comprises an inner and outer wall defining a closed space therebetween, an inlet and an outlet in fluid communication with said space, and a channel for the flow of fluid defined in said space between said inlet and said outlet, said channel being defined by a plurality of support structures provided in said space, each such structure having at least one opening therein, wherein such opening on each structure is at an opposite end from such opening on an adjacent structure.

11. A panel for use as a side wall in a concrete slurry storage container comprising an inner and outer wall defining a closed space therebetween, an inlet and an outlet in fluid communication with said space, and a channel for the flow of fluid defined in said space between said inlet and said outlet.

12. The panel of claims 11 wherein said channel is defined by a plurality of support structures provided in said space, each such structure having at least one opening therein, wherein such opening on each structure is at an opposite end from such opening on an adjacent structure.

13. A method of affecting the temperature of slurry in a concrete storage container comprising the steps of:
a. introducing slurry into an open-top container having a base and a plurality of upwardly extending side panels, each of said side panels comprising an inner and outer wall defining a closed space therebetween, an inlet and an outlet in fluid communication with said space, and a channel for the flow of fluid in said space between said inlet and said outlet,
b. connecting the inlet of a first side panel to a fluid pump, and connecting the outlet of a last side panel to an exit pipe;
c. connecting the outlets of each remaining side panel to the inlet of an adjacent side panel forming a system; and
d. pumping a fluid having a selected temperature through said system.

14. The method of claim 13 comprising the additional step of periodically agitating said slurry.

15. The method of claim 13 wherein each channel is defined by a plurality of support structures provided in said space, each such structure having at least one opening therein, wherein such opening on each structure is at an opposite end from such opening on an adjacent structure.

16. A method of erecting a concrete slurry container comprising the steps of;
a. placing a base on the ground;
b. attaching a plurality of removable, upwardly extending side panels around the perimeter of the base and to each other defining an enclosure with an open top; and
c. suspending at least one agitator above said enclosure said agitator having a shaft that it extends into said enclosure and at least one blade at the end of said shaft.

17. The method of claim 16 wherein each of said side panels comprises an inner and outer wall defining a closed space therebetween, an inlet and an outlet in fluid communication with said space, and a channel for the flow of fluid in said space between said inlet and said outlet, said method comprising the additional steps of:
d. connecting the inlet of a first side panel to a fluid pump, and connecting the outlet of a last side panel to an exit pipe; and
e. connecting the outlets of each remaining side panel to the inlet of an adjacent side panel forming a system.

18. The method of claim 16 wherein each of said side panels comprises an inner and outer wall defining a closed space therebetween, an inlet and an outlet in fluid communication with said space, and a channel for the flow of fluid defined in said space between said inlet and said outlet, said channel being defined by a plurality of support structures provided in said space, each such structure having at least one opening therein, wherein such opening on each structure is at an opposite end from such opening on an adjacent structure.

19. A method of expanding a concrete storage container comprising the steps of:
a. removing one of a plurality of removable, upwardly extending panels attached around the perimeter of a base forming said storage container, said removal forming an opening;
b. providing an additional base adjacent to said existing base at said opening; and
c. attaching a plurality of removable, upwardly extending panels around the perimeter of the additional base and to each other and to the panels adjacent to said opening to form an expanded storage container.

20. A method of expanding a concrete storage container comprising the steps of:
a. removing an end panel from a plurality of removable, upwardly extending panels attached around the perimeter of a base forming said storage container, said removal forming an opening;
b. providing an additional base adjacent to said existing base at said opening; and
c. attaching a pair of upwardly extending panels to said additional base and to the panels adjacent to said opening; and
d. attaching said removed end panel to said pair of side panels and to said extended base to enclose said container.

21. A method of cleaning a concrete storage container comprising the steps of:
a. removing one of a plurality of removable, upwardly extending panels attached around the perimeter of a base forming said storage container, said removal forming an opening;
b. entering said container through said opening;
c. cleaning the interior of said container; and
d. replacing said removed panel, closing said opening.
